(19) United States
(12) Patent Application Publication
(10) Pub. No.: US 2009/0103591 A1
(43) Pub. Date: Apr. 23, 2009

(54) Bit confidence weighting based on levels of interference

(75) Inventors: Sujai Chari, San Francisco, CA (US); Adam L. Schwartz, San Carlos, CA (US); Daryl Arnold Kaiser, Los Gatos, CA (US)

Correspondence Address: Tzero Technologies, PO Box 641867, San Jose, CA, 95164-1867, US

(73) Assignee: Tzero Technologies, Inc.

(21) Appl. No.: 11/982,965

(22) Filed: Nov. 6, 2007

Related U.S. Application Data
(60) Provisional application No. 60/999,507, filed on Oct. 18, 2007.

(51) Int. Cl. H04B 1/713

(52) U.S. Cl. 375/136; 375/E01.033

(57) ABSTRACT

Methods and systems of frequency hopping communication are disclosed. One method includes a receiver obtaining a frequency hopping sequence, wherein the frequency hopping sequence defines a time sequence of reception through each of a plurality of frequency hopping bands. For each of the plurality of frequency hopping bands, the receiver estimates an interference level and assigns a band weight to the frequency hopping band based on the estimated interference level. The receiver receives a signal that includes symbols occupying the plurality of frequency hopping bands according to the frequency hopping sequence, and demodulates the symbols producing a stream of estimated bit values and corresponding bit value confidence levels. The bit value confidence levels of each of the estimated bit values are adjusted according to the band weight of a corresponding frequency hopping band.

### FIELD OF THE DESCRIBED EMBODIMENTS

The described embodiments relate generally to wireless communications. More particularly, the described embodiments relate to a method and apparatus for weighting bit value confidence levels based on detected interference.

### BACKGROUND

The Federal Communications Committee (FCC) has mandated that UWB radio transmission can legally operate in the frequency range of 3.1 GHz to 10.6 GHz. The transmit power requirement for UWB communications is that the maximum average transmit Effective Isotropic Radiated Power (EIRP) is −41.25 dBm/MHz in any transmit direction.

One advantage of operating over wide bandwidths as provided by UWB systems is the substantial immunities to interference that can be realized. In order to optimize receiver performance in the presence of interference, the receiver should determine the location and magnitude of the interference, and communicate this information to a receiver decoder.

A typical WiMedia UWB receiver includes soft decoding that can be sensitive to interference and noise. The noise can be accounted for by weighting the decoding. That is, signals with low SNR are weighted less than signals with high SNR. Interference, however, can appear as signal energy, and therefore, can degrade the benefits provided by weighting.

It is desirable to have a method of mitigating the detrimental effects of interference of a received signal on soft decoding to the received signal.

### SUMMARY

An embodiment includes a method of frequency hopping communication. The method includes a receiver obtaining a frequency hopping sequence, wherein the frequency hopping sequence defines a time sequence of reception through each of a plurality of frequency hopping bands. For each of the plurality of frequency hopping bands, the receiver estimates an interference level and assigns a band weight to the frequency hopping band based on the estimated interference level. The receiver receives a signal that includes symbols occupying the plurality of frequency hopping bands according to the frequency hopping sequence, and demodulates the symbols producing a stream of estimated bit values and corresponding bit value confidence levels. The bit value confidence levels of each of the estimated bit values are adjusted according to the band weight of a corresponding frequency hopping band.

Another embodiment includes a method of communication. The method includes a receiver receiving a signal with symbols in the presence of interference, wherein the interference is determined to have a repeating pattern over time. The receiver estimates the repeating pattern of interference and assigns time weights corresponding to an estimated interference level during portions of the pattern in which the interference is above a threshold. The symbols are demodulated producing a stream of estimated bit values and corresponding bit value confidence levels. The bit value confidence levels are adjusted according to the time weights.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a frequency spectrum of frequency bands, and an example of a sequence for transmission of data symbols within these bands.

FIG. 2 is a table that shows examples of actual and estimated values of SINR for various levels of SIR and SNR of a received wireless signal.

FIG. 3 shows a time-line of an example of a frequency hopping signal of interest (SOI) and an interfering signal that transmits over a within a single frequency band.

FIG. 4 is a flow chart that shows one example of steps of a method of frequency hopping communication.

FIG. 5 is a flow chart that shows one other example of steps of a method of frequency hopping communication.

FIG. 6 is a flow chart that shows one example of steps of a method of communication.

### DETAILED DESCRIPTION

The embodiments described include methods of weighting bit value confidence levels of estimated bit values of received and demodulated signals based on levels of interference within frequency bands. The levels of interference can known based on history, or they can be estimated or measured. The embodiments provide mitigation of the effects of interference on soft decoding.

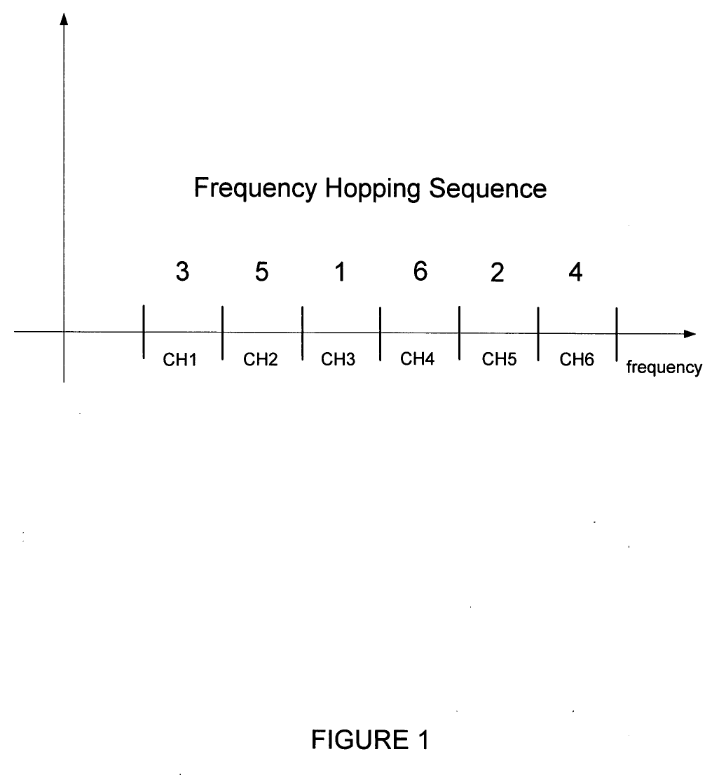

FIG. 1 shows a frequency spectrum of communication frequency bands (hereafter referred to, interchangeably, as frequency hopping bands or frequency bands), and an example of a sequence of frequency bands for transmission of data symbols. As shown, this example includes six communicating frequency bands (labeled CH1 through CH6) that are defined by a frequency hopping sequence. Frequency-hopping is a method of transmitting radio signals by switching a carrier among many frequency bands, using a deterministic or pseudorandom sequence known to both transmitter and receiver. In this example, symbols of the signal are transmitted such that the energy of the first symbol occupies frequency band 3, the next symbol's energy occupies frequency band 5 and so forth. After the sixth symbol, which occupies frequency band 4, the pattern may repeat or it may be followed with a continuation of a pseudorandom sequence.

An embodiment of UWB uses multi-carrier (orthogonal frequency division multiplexing (OFDM)) signals. The OFDM signals are transmitted according to a frequency hopping sequence. Before being modulated and transmitted, a transmit data stream is passed through a convolutional coder and an interleaver.

At a receiver, an embodiment includes a decoder (such as a Viterbi decoder) for demodulating and de-interleaving the received OFDM symbols. An embodiment includes soft-decoding in which the input to the decoder is a sequence of soft decisions (bit values and estimated bit value confidence levels) reflecting log-likelihood ratios of each received bit being a “1” to that of the bit being a “0”. The log-likelihood ratio is dependent on the signal to noise and interference ratio (SINR).

The impact of noise and interference on the estimated SINR and subsequently the decoder performance depends on the statistical properties of the noise and interference. Thermal noise can be presumed to be AWGN (Additive White Gaussian Noise) even if it is not strictly AWGN in practice. The characteristics of the interfering signal can vary considerably based on the source of the interference. For UWB systems, examples of interferers include WiMax and other UWB interferers. Interference from WiMax signals typically affects a few subcarriers of the UWB signal. The interfering WiMax signal is uncorrelated with respect to the desired UWB signal and can be approximated as Gaussian noise. In contrast, interference from other UWB sources will be wideband and typically affects complete frequency bands of the desired UWB signal.

Depending of the relative distances of the transmitter of the SOI (signal of interest) and the interfering source to the receiver, the interference may be substantially greater than the received signal of interest leading to a small SINR. The receiver can approximate the SINR using channel estimation symbols with known transmitted data during the preamble of the SOI. A straightforward implementation of channel and noise estimation for a multi-carrier signal is shown below.

Received Signal

Z_{k,i}=X_{k,i}Hₖ+Y_{k,i}+N_{k,i},

Channel Estimation

$${\hat{H}}_{k} = \frac{1}{N} {\sum }_{i = 1}^{N} \frac{{Z}_{k , i}}{{X}_{k , i}} ,$$

Noise Estimation

$${\hat{σ}}_{k}^{2} = \frac{1}{N} {\sum }_{i = 1}^{N} {\vert {Z}_{k , i} - {\hat{H}}_{k} {X}_{k , i} \vert}^{2} ,$$

where Z_{k,i} is the received sample at subcarrier k for symbol index i,
X_{k,i} is the transmitted data for subcarrier k for symbol index i,
   Y_{k,i} is the component of the received sample from the interfering signal at subcarrier k for symbol index i,
   N_{k,i} is the noise component present at subcarrier k for symbol index i,
   Hₖ is the actual channel for subcarrier k,
Ĥₖ is the channel estimate for subcarrier k,
\hat{σ}ₖ² is the noise variance estimate for subcarrier k

In one UWB embodiment, there are 2, 3, or 6 channel estimation symbols depending on the number of channel estimation symbols in each frequency hopping band. Since the WiMax interferer is uncorrelated with the SOI, when averaging is used across the channel estimation symbols, the interferer is suppressed by a factor of 10*log₁₀(N) with respect to the SINR of a single symbol, where N is the number of channel estimation symbols. Despite this correlation gain, the approximated SINR based on the preamble is very inaccurate for low SINR. The same correlation gain holds true for a wideband interferer as well except that the correlation gain varies per subcarrier based on the variation of the interference power across the frequency band.

For example, consider the case where the signal and interferer are both UWB systems. If the desired signal source and the interferer both transmit at the same signal power and the links from both devices to the receiver are LOS (line of sight), then a SIR of −6 dB represents the case where the interferer to receiver distance, dᵢₙₜ, is approximately half the distance from the desired signal transmitter to the receiver, d_{ref}. Using the channel and noise estimation to approximate the SINR presented above, the resulting estimated SINR can be expressed using the following equation:

$${SINR}_{est} ( dB ) = 10 {log}_{10} ( \frac{1 + \frac{1}{N} {( \frac{{d}_{ref}}{{d}_{int}} )}^{2} + \frac{{σ}^{2}}{N}}{\frac{1}{N} {( \frac{{d}_{ref}}{{d}_{int}} )}^{2} + \frac{{σ}^{2}}{N}} ) ,$$

where σ²=1/SNR,
N is the number of symbols used for channel estimation.

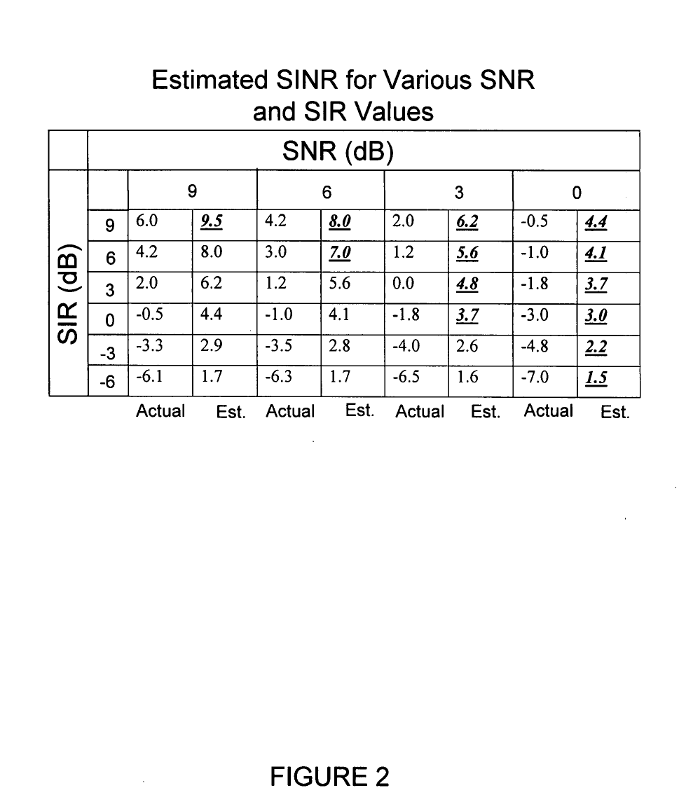

FIG. 2 is a table that shows examples of actual and estimated values of SINR (signal to interference and noise ratio) for various levels of SIR (signal to interference ratio) and SNR (signal to noise ratio) of a received wireless signal. The table shows that bit estimates, such as, log likelihood ratios can be made inaccurate due to the presence of noise and interference. That is, the estimated values of SINR can end up being greater than the actual values of SNR for the received signals. Therefore, the decoding can mistakenly assume that contributing interference is desired signal energy, and over-estimate the confidence of a bit value. Decoding convolutional coded signals using, for example, a Viterbi decoder is sensitive to the inaccurate log-likelihood ratios that can result in the presence of interference.

The vertical column of the table of FIG. 2 shows various levels of SIR of the received signal varying from −6 dB to 9 dB. The horizontal row shows various levels of SNR of the received SOI varying from 0 dB to 9 dB. The actual resulting SINR values are shown and designated as “Actual” for the various levels of SIR and SNR. The revealing estimated SINR values of interest are italicized, underlined and bolded. That is, these are values in which the estimated SINR values are greater than the SNR values of the received signals. Based on the estimated SINR value, the decoder may suggest a higher bit value confidence level than is justified, and higher than it would be if based on the SNR only. The result is that these exaggerated SINR estimates can lead to weighting the affected bits to the detriment of the performance of the soft decoding of the bit values of the received signals.

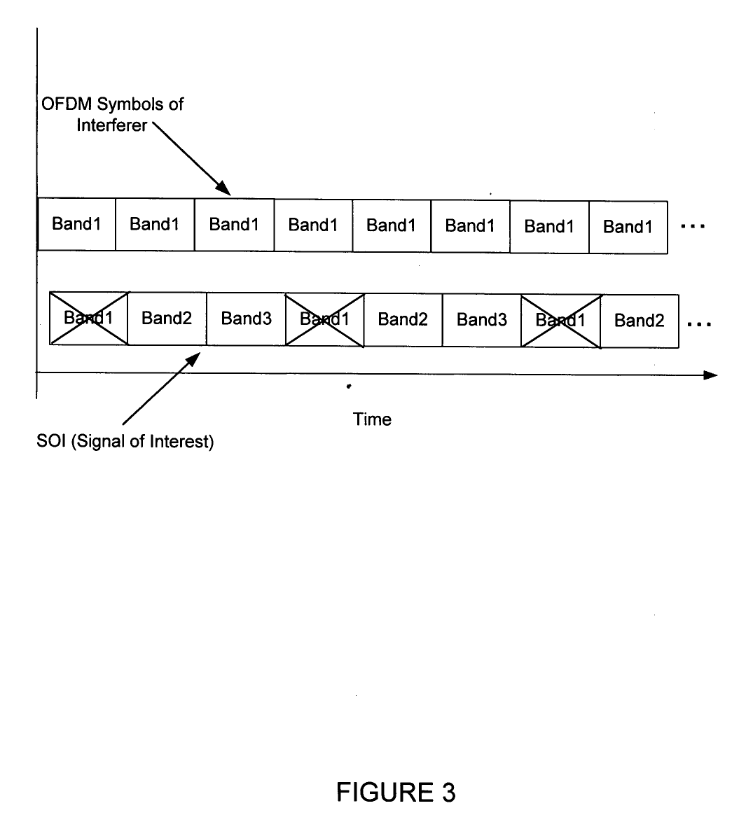

FIG. 3 shows a time-line of an example of a frequency hopping signal of interest (SOI) and an interfering signal that transmits over a single frequency band (the interfering signal does not hop). That is, the SOI as shown over time, cycles through Band 1, to Band 2, to Band 3. An interfering signal can include, for example, transmission of signal within a single frequency band (Band 1) continuously. Therefore, every time the SOI cycles through the Band 1, the SOI suffers from the interference caused by the interfering signal. The interference, as opposed to noise, can cause problems for decoding of convolutional coded signals. Therefore, the interference can be particularly problematic.

Configurations of the described embodiments include detecting and averaging the interference over time providing more accurate estimates of the interference, and therefore, more accurate band weightings. As can be inferred from previous discussion, instantaneous averaging of the interference is not as accurate, and can provide inaccurate band weightings. Estimating and averaging the interference over time provides an additional degree of accuracy. Band weighting rather than bit weighting can also be advantageous for wireless channels. For example, for a UWB receiver, band weighting is more accurate than bit weighting when the interfering signal is another UWB signal, or when the interfering signal is saturating a front-end of the receiver (that is, for example, saturating the RF front-end (e.g. LNA) or causing clipping of a signal input to a receiver ADC).

The disclosed embodiments provide methods for mitigating the effects of the interference by identifying repeating patterns of interference and using the knowledge of the presence of interference to adjust the process of decoding the received signal. For each of the plurality of frequency hopping bands, the receiver estimates an interference level and assigns a band weight to the frequency hopping band based on the estimated interference level. The weight is adapted over time as interference levels change. One embodiment maintains the weight for the time duration of a packet. A packet typically includes a frame of data which typically includes several symbols. The receiver demodulates received symbols producing a stream of estimated bit values and corresponding bit value confidence levels (based on the estimated SINR). The bit value confidence levels of each of the estimated bit values can then be adjusted according to the band weight of a corresponding frequency hopping band. That is, band weights for high-interference bands can reduce the bit value confidence level, and band weights for low-interference bands can increase the bit value confidence. The identification of interference can be based on a priori knowledge or developed over time. Knowledge of the interference is fed to the signal decoder rather than having the signal decoder attempt to instantaneously identify the presence of interference and react appropriately to it. Accumulating interference estimates over time leads to more accurate and efficient decoding than relying on instantaneous estimates.

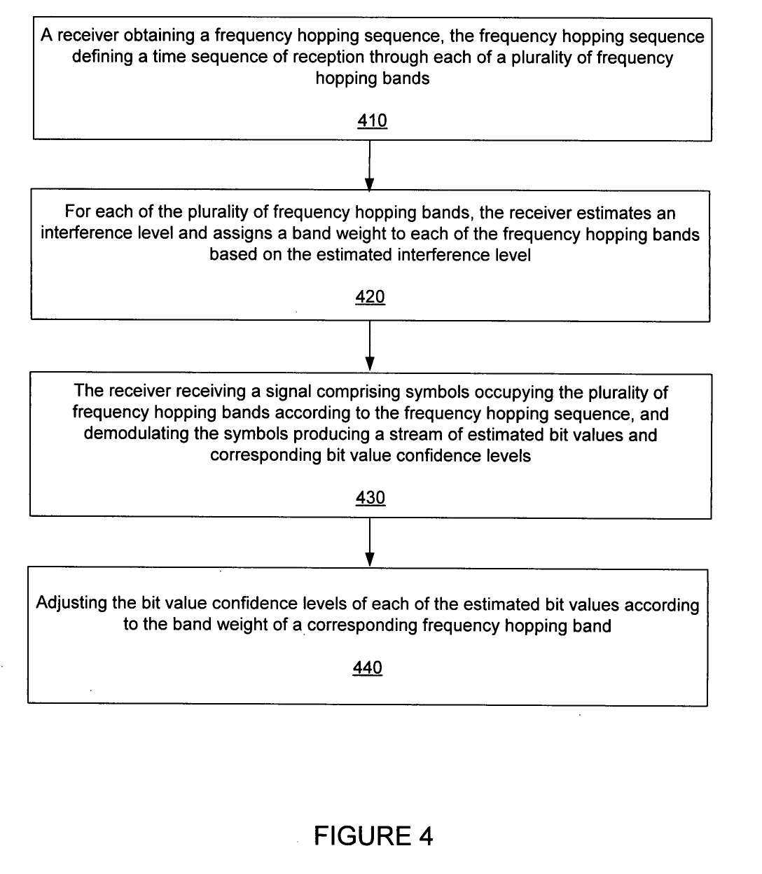

FIG. 4 is a flow chart that shows one example of steps of a method of frequency hopping communication. A first step 410 includes a receiver obtaining a frequency hopping sequence, the frequency hopping sequence defining a time sequence of reception through each of a plurality of frequency hopping bands. A second step 420 includes for each of the plurality of frequency hopping bands, the receiver estimating an interference level and assigning a band weight to each frequency hopping band based on the estimated interference level. A third step 430 includes the receiver receiving a signal comprising symbols occupying the plurality of frequency hopping bands according to the frequency hopping sequence, and demodulating the symbols producing a stream of estimated bit values and corresponding bit value confidence levels. A fourth step 440 includes adjusting the bit value confidence levels of each of the estimated bit values according to the band weight of a corresponding frequency hopping band.

An embodiment includes the signal being a multi-carrier signal. The multi-carrier signal includes multi-carrier symbols, wherein, each multi-carrier symbol includes modulated carrier tones spaced across a frequency hopping band. For this embodiment, the receiver estimating an interference level for each of the plurality of frequency hopping bands includes estimating interference associated with each sub-carrier of multi-carrier symbols transmitted through each of the plurality of frequency hopping bands, and estimating interference of each of the frequency hopping bands based on the estimated interference associated with each sub-carrier of the multi-carrier symbols. Again, this information is developed over time and the decoder utilizes this information to improve its ability to perform in the presence of the interference.

For frequency bands having an estimated interference level above a threshold, the band weights can be used to adjust the bit value confidence levels of estimated bit values to substantially zero. That is, if the interference for a band is detected to be above the threshold, the bit value confidence level of estimated bit values corresponding to symbols transmitted in the band are basically set to zero, or a small value relative to the confidence level determined from the estimated SINR.

Another embodiment includes the receiver estimating an interference level and assigning a band weight to the frequency hopping band based on the estimated interference level for each of the plurality of frequency hopping bands over time. That is, for each frequency hopping band, a running percentage of time the estimated interference for the frequency hopping band is greater than the predetermined threshold is determined. Based on the running percentage the band weight for each frequency hopping band is assigned. An alternate embodiment includes maintaining a running percentage of time the estimated interference for each frequency hopping band is less than the predetermined threshold and assigning band weights according to the percentage for each band.

High-levels of interference can also cause analog portions of receivers to saturate, causing signal distortion. Therefore, avoidance of frequency bands that include interference above a threshold can reduce the possibility of front-end section circuitry saturating. Accordingly, an embodiment includes setting an automatic gain control (AGC) of the receiver for each of the plurality of frequency hopping bands based at least in part on the estimated interference level of each of the plurality of frequency hopping bands. The setting of the AGC can include accounting for noise, signal and interference energy within frequency hopping transmission bands that have estimated interference levels above a threshold for greater than a predetermined percentage of time.

If there is no a priori knowledge about the interference, then blind detection techniques can be applied. Generally speaking, these techniques utilize knowledge of the signal of interest and other known impairments (e.g. thermal noise, spurs, etc.) and attempt to determine distinguishing characteristics in the received signal which cannot be attributed to the known signal of interest or the known impairments. Interference can be static or dynamic (that is, time varying). The static interference detection techniques will be presented first followed by the dynamic interference detection techniques which will utilize the static detection techniques combined with monitoring of various statistics over time.

Interference detection can be performed in the presence of the signal of interest (SOI) or during quiet periods where there is no SOI being transmitted. In the case where there is no SOI, two approaches to detecting the interference include energy detection and coherent detection.

Energy detection involves estimating the received signal energy over time. When there is no SOI, the received signal power should be due to thermal noise and other known receiver induced impairments whose power can be pre-determined and denoted as Pₙ and referred to as the background noise power. However, if there is interference present, the interfering signal is not correlated with the thermal noise and receiver induced impairments and consequently, the measured received signal power, Pᵢ₊ₙ, is the sum of the background noise power and the received signal power due to interference, Pᵢ. Therefore, the estimate of the interference power level, \hat{P}ᵢ can be obtained by subtracting the background signal power from the total measured received signal power:

\hat{P}ᵢ=Pᵢ₊ₙ−Pₙ

If the SOI uses frequency hopping, then the interference power level can be estimated for each frequency band using the aforementioned approach. Specifically, the receiver can be configured to measure the signal power in a given band. Once the interference power has been estimated for that band, the receiver can proceed to measure the next band and repeat the procedure until an independent interference power level estimate has been obtained for each frequency band.

When there are multiple interferers or when the received interference power is less than the background noise power, energy detection may not provide accurate estimates of the interference level. In these cases, it may be beneficial to use coherent detection. One example of coherent detection is based on correlating the received signal with a known synchronization sequence transmitted by the interferer. The correlation output of the received signal with the synchronization sequence will suppress the background noise and other interferers. The power of the correlation output over a pre-determined interval can be used as an approximation of the power of the interference.

Interference levels can also be estimated in the presence of the SOI. In order to obtain accurate estimates, the SOI power, Pₛ, needs to be estimated and subtracted from the total received signal power, Pₛ₊ᵢ₊ₙ. The SOI power can be more accurately estimated when the interference is not present by using the approach described above for estimating interference when the SOI is not present. Alternatively, the channel estimates obtained for the SOI can be used to approximate the power of the SOI:

$${\hat{P}}_{s} = {g}_{0} {\sum }_{k = 1}^{M} {\vert {\hat{H}}_{k} \vert}^{2}$$

where Ĥₖ is the channel estimate for subcarrier k,
and gₒ is a constant determined based on known transmit power of the SOI and the gain in the receiver

Note that in order for the channel estimates to be accurate, the channel estimates must be determined when the interference is not present or be sufficiently averaged across many symbols so that the interference does not corrupt the estimate.

The interference detection techniques described for static interference detection can be extended to handle the case where the interference level is time varying. The time varying nature of the interference may occur in a pattern that can be predicted or in a random manner. One example of interference that follows a pattern which is predictable is an interferer which transmits using a frequency hopping sequence (that is, the hopping sequence is deterministic and the receiver either has a priori knowledge of the sequence or can determine the sequence based on the pattern of detection of interference over a finite segment of time). If the SOI is being received in a particular frequency band which is one of the bands in the frequency hopping sequence used by the interferer, then the receiver can predict the subset of received symbols corresponding to the SOI which will be corrupted by the interference. The prediction of this pattern of interference can subsequently be utilized to declare erasures as described previously.

If the transmission of the interfering signal does not follow a deterministic or predictable pattern, the receiver can still determine the probability of the presence of the interference as well as the amount of degradation to the SOI. Using the aforementioned interference detection techniques, the levels and presence of the interference can be continually monitored over time. Based on these statistics, a probability density function (PDF) can be constructed which can subsequently be used to determine the dynamic thresholds described previously used in the comparisons for declaring erasures. For instance, the thresholds could be a function of the mean and standard deviation of the interference PDF.

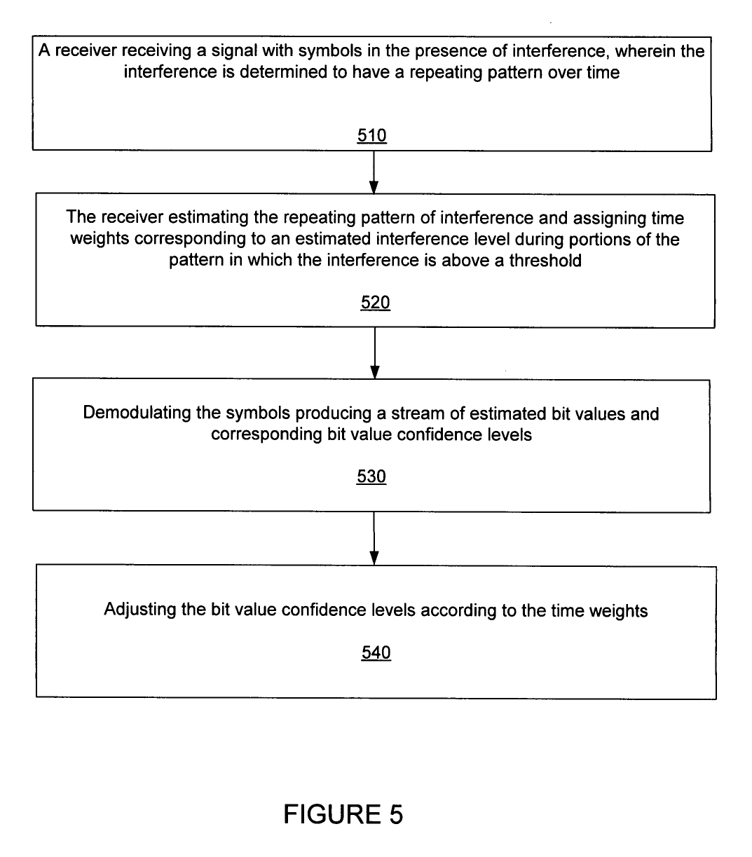

FIG. 5 is a flow chart that shows one example of steps of a method of communication. A first step 510 includes a receiver receiving a signal with symbols in the presence of interference, wherein the interference is determined to have a repeating pattern over time. A second step 520 includes the receiver estimating the repeating pattern of interference and assigning time weights corresponding to an estimated interference level during portions of the pattern in which the interference is above a threshold. A third step 530 includes demodulating the symbols producing a stream of estimated bit values and corresponding bit value confidence levels. A fourth step 540 includes adjusting the bit value confidence levels according to the time weights.

This method is more general than the previous method. This method includes, for example, a situation in which the signal of interest and the interfering signal of FIG. 3 are reversed. That is, for example, the interfering signal can be a frequency hopping signal from another wireless system, and the SOI can be a transmission signal that does not frequency hop. The net result is that the SOI suffers from interference periodically, and with a repeating pattern. Once the pattern is recognized, the bit value confidence levels can be adjusted to reflect the pattern of interference within the receive signal of interest.

For example, if the interfering signal is a frequency hopping signal, such as, shown in FIG. 3, then a time pattern can exist in which the interference signal interferes with a desired received signal, for example, in band 1. The receiver can detect interference of the interfering signal exceeding an average energy level. Based on the timing of the interfering signal exceeding the energy threshold, the receiver can identify the pattern. The receiver can then declare erasures or the time weights based on the pattern.

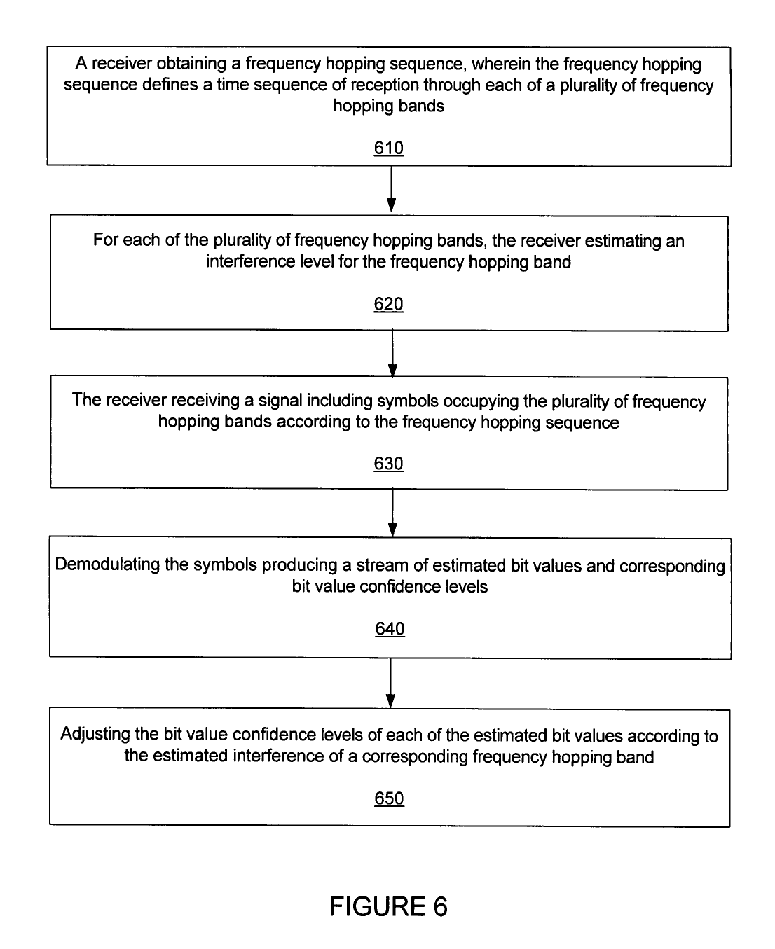

FIG. 6 is a flow chart that shows one other example of steps of a method of frequency hopping communication. A first step 610 includes a receiver obtaining a frequency hopping sequence, wherein the frequency hopping sequence defines a time sequence of reception through each of a plurality of frequency hopping bands. A second step 620 includes for each of the plurality of frequency hopping bands, the receiver estimating an interference level for the frequency hopping band. A third step 630 includes the receiver receiving a signal including symbols occupying the plurality of frequency hopping bands according to the frequency hopping sequence. A fourth step 640 includes demodulating the symbols producing a stream of estimated bit values and corresponding bit value confidence levels. A fifth step 650 includes adjusting the bit value confidence levels of each of the estimated bit values according to the estimated interference of a corresponding frequency hopping band.

Although specific embodiments have been described and illustrated, the embodiments are not to be limited to the specific forms or arrangements of parts so described and illustrated.

What is claimed:

1. A method of frequency hopping communication, comprising:
a receiver obtaining a frequency hopping sequence, the frequency hopping sequence defining a time sequence of reception through each of a plurality of frequency hopping bands; and
for each of the plurality of frequency hopping bands, the receiver estimating an interference level and assigning a band weight to the frequency hopping band based on the estimated interference level;
the receiver receiving a signal comprising symbols occupying the plurality of frequency hopping bands according to the frequency hopping sequence, and demodulating the symbols producing a stream of estimated bit values and corresponding bit value confidence levels; and
adjusting the bit value confidence levels of each of the estimated bit values according to the band weight of a corresponding frequency hopping band.

2. The method of claim 1, wherein the signal is a multi-carrier signal.

3. The method of claim 2, wherein the receiver estimating an interference level for each of the plurality of frequency hopping bands, comprises:
estimating interference associated with each sub-carrier of multi-carrier symbols transmitted through each of the plurality of frequency hopping bands;
estimating interference of each of the frequency hopping bands based on the estimated interference associated with each sub-carrier of the multi-carrier symbols.

4. The method of claim 2, wherein the multi-carrier signal comprises multi-carrier symbols, and each multi-carrier symbol comprises modulated carrier tones spaced across a frequency hopping band.

5. The method of claim 1, wherein the band weights adjust the bit value confidence levels of estimated bit values that correspond to the frequency hopping bands having an estimated interference level above a threshold to substantially zero.

6. The method of claim 1, wherein the receiver estimating an interference level and assigning a band weight to the frequency hopping band based on the estimated interference level for each of the plurality of frequency hopping bands, further comprises:
for each frequency hopping band, estimating a running percentage of time the estimated interference for the frequency hopping band is greater than the predetermined threshold; and
assigning the band weight for each frequency hopping band based on the running percentage of time.

7. The method of claim 1, wherein the receiver estimating an interference level comprises:
measuring signal energy for each of the plurality of frequency bands.

8. The method of claim 1, wherein the receiver estimating an interference level comprises:
scanning each of the plurality of frequency bands for a UWB signal intended for other receivers.

9. The method of claim 1, wherein the receiver estimating an interference level and assigning a band weight to the frequency hopping band based on the estimated interference level for each of the plurality of frequency hopping bands, further comprises:
for each frequency hopping band, estimating a running percentage of time the estimated interference for the frequency hopping band is less than the predetermined threshold; and
assigning the band weight for each frequency hopping band based on the running percentage of time.

10. The method of claim 1, further comprising setting an automatic gain control (AGC) of the receiver for each of the plurality of frequency hopping bands base at least in part on the estimated interference level of each of the plurality of frequency hopping bands.

11. The method of claim 10, wherein the setting the AGC comprises:
accounting for noise, signal and interference energy within frequency hopping transmission bands that have estimated interference levels below the predetermined threshold for greater than a predetermined percentage of time.

12. A method of communication, comprising:
a receiver receiving a signal with symbols in the presence of interference, wherein the interference is determined to have a repeating pattern over time;
the receiver estimating the repeating pattern of interference and assigning time weights corresponding to an estimated interference level during portions of the pattern in which the interference is above a threshold;
demodulating the symbols producing a stream of estimated bit values and corresponding bit value confidence levels; and
adjusting the bit value confidence levels according to the time weights.

13. A method of frequency hopping communication, comprising:
a receiver obtaining a frequency hopping sequence, the frequency hopping sequence defining a time sequence of reception through each of a plurality of frequency hopping bands; and
for each of the plurality of frequency hopping bands, the receiver estimating an interference level for the frequency hopping band;
the receiver receiving a signal comprising symbols occupying the plurality of frequency hopping bands according to the frequency hopping sequence;
demodulating the symbols producing a stream of estimated bit values and corresponding bit value confidence levels; and
adjusting the bit value confidence levels of each of the estimated bit values according to the estimated interference of a corresponding frequency hopping band.

14. he method of claim 13, wherein for frequency hopping bands having an estimated interference level above a threshold, the bit value confidence levels for estimated bit values corresponding to the frequency hopping bands are adjusted to substantially zero.

15. The method of claim 13, wherein the signal is a multi-carrier signal.

16. The method of claim 15, wherein the receiver estimating an interference level for each of the plurality of frequency hopping bands, comprises:
estimating interference associated with each sub-carrier of multi-carrier symbols transmitted through each of the plurality of frequency hopping bands;
estimating interference of each of the frequency hopping bands based on the estimated interference associated with each sub-carrier of the multi-carrier symbols.

17. The method of claim 15, wherein the multi-carrier signal comprises multi-carrier symbols, and each multi-carrier symbol comprises modulated carrier tones spaced across a frequency hopping band.

18. The method of claim 13, wherein the receiver estimating an interference level for each of the plurality of frequency hopping bands, further comprises:
for each frequency hopping band, estimating a running percentage of time the estimated interference for the frequency hopping band is greater than the predetermined threshold; and
estimating the interference level for each frequency hopping band based on the running percentage of time.

19. The method of claim 13, wherein the receiver estimating an interference level for each of the plurality of frequency hopping bands, further comprises:
for each frequency hopping band, estimating a running percentage of time the estimated interference for the frequency hopping band is less than the predetermined threshold; and
estimating the interference level for each frequency hopping band based on the running percentage of time.

20. The method of claim 13, further comprising setting an automatic gain control (AGC) of the receiver for each of the plurality of frequency hopping bands base at least in part on the estimated interference level of each of the plurality of frequency hopping bands.
